(19) United States
(12) Patent Application Publication
(10) Pub. No.: US 2012/0165028 A1
(43) Pub. Date: Jun. 28, 2012

(54) METHOD OF CONTROLLING TRANSMISSION POWER OF FEMTOCELLS FOR INTERFERENCE CONTROL

(75) Inventors: Hyung Sub KIM, Seoul (KR); Yeong Jin KIM, Daejeon (KR); Yeon Seung SHIN, Daejeon (KR)

(73) Assignee: Electronics and Telecommunications Research Institute, Daejeon (KR)

(21) Appl. No.: 13/334,692

(22) Filed: Dec. 22, 2011

(30) Foreign Application Priority Data
Dec. 23, 2010 (KR) 10-2010-0133637

(51) Int. Cl. H04W 52/16

(52) U.S. Cl. 455/449

(57) ABSTRACT

Disclosed is a method of controlling transmission power of femtocells for interference control. The method includes (a) setting transmission power of femtocells to initial transmission power, (b) establishing inequalities between received signal to interference ratios (SIRs) of I user terminals and SIRs satisfying service requirements of the terminals as I simultaneous inequalities, (c) identifying whether the inequalities constituting the simultaneous inequalities are satisfied, and (d) maintaining currently adjusted transmission power and stopping transmission power adjustment of the femtocells if all the inequalities are satisfied in operation (c), wherein operations (c) and (d) are iterated while inequalities are sequentially selected one by one from at least some inequalities if at least some inequalities are not satisfied in operation (c) and transmission power is adjusted one by one in terms representing the transmission power of femtocells in the inequalities.

### CLAIM FOR PRIORITY

This application claims priority to Korean Patent Application No. 10-2010-0133637 filed on Dec. 23, 2010 in the Korean Intellectual Property Office (KIPO), the entire contents of which are hereby incorporated by reference.

### BACKGROUND

1. Technical Field

Example embodiments of the present invention relate to inter-cell interference control technology for use in mobile communication systems, and more particularly, to a transmission power control method of improving the performance of a macrocell by controlling transmission power of femtocells in a heterogeneous network environment in which femtocells overlap macrocells.

2. Related Art

Methods of constructing and operating independent networks for use in homes or small offices are emerging as new technology.

A network of a small-size femtocell exhibits the performance of high efficiency and may be easily developed and operated because a distance between a base station of the femtocell and each mobile terminal is very short compared to an existing macrocell.

Frequency allocation between the femtocell and the macrocell is divided into two schemes. The two schemes are a co-channel frequency allocation scheme in which the macrocell and the femtocell share the same frequency band and an orthogonal channel frequency allocation scheme in which a total frequency band of a system is divided and the macrocell and the femtocell use division frequency bands, which do not overlap each other.

The co-channel frequency allocation scheme has an advantage in that although a frequency usage rate is high, there is interference between the macrocell and the femtocell. On the other hand, the orthogonal channel frequency allocation scheme has a disadvantage in that although there is no interference between the macrocell and the femtocell, frequency use efficiency is low.

That is, it is important for the co-channel frequency allocation scheme to eliminate interference between the macrocell and the femtocell. In particular, there is a transmission power difference between base stations of the macrocell and the femtocell. Because of a relative distance, interference from the macrocell to the femtocell is negligible, but interference from the femtocell to the macrocell may be problematic.

### SUMMARY

Accordingly, example embodiments of the present invention are provided to substantially obviate one or more problems due to limitations and disadvantages of the related art.

Example embodiments of the present invention provide a method of controlling transmission power of femtocells that may improve quality of service (QoS) for users within a macrocell by efficiently controlling transmission power of femtocells that may interfere with the users within the macrocell in a heterogeneous network environment in which macrocells overlap femtocells.

In some example embodiments, a method of controlling transmission power of femtocells when there are I (I is a natural number) user terminals (i=1, . . . , I) that are receiving service from one macrocell (m) among M (M is a natural number) macrocells in a heterogeneous network environment in which the M macrocells overlap F (F is a natural number) femtocells, includes: (a) setting the transmission power of the femtocells to initial transmission power; (b) establishing inequalities between received signal to interference ratios (SIRs) of the I user terminals and SIRs satisfying service requirements of the terminals as I simultaneous inequalities; (c) identifying whether the inequalities constituting the simultaneous inequalities are satisfied; and (d) maintaining currently adjusted transmission power and stopping transmission power adjustment of the femtocells if all the inequalities are satisfied in operation (c), wherein operations (c) and (d) are iterated while inequalities are sequentially selected one by one from at least some inequalities if the at least some inequalities are not satisfied in operation (c) and transmission power is adjusted one by one in terms representing the transmission power of femtocells in the inequalities.

In the method, the initial transmission power in operation (a) may be transmission power for maintaining received signal intensity from a macrocell at a predetermined distance from each of the femtocells and received signal intensity from the femtocell at the same level.

In the method, the received SIRs of the I user terminals in operation (b) may be defined by:

$$SIR = \frac{{p}_{mi} {g}_{mi}}{{\sum }_{k = 1 , k \neq i}^{M} {p}_{ki} {g}_{ki} + {\sum }_{k = 1}^{F} {p}_{ki}^{f} {g}_{ki}^{f} + N} ,$$

where M denotes the number of macrocells, F denotes the number of femtocells, I denotes the number of users, N denotes thermal noise, pₘᵢ denotes transmission power between a macrocell base station (m) and the terminal (i), gₘᵢ denotes a path gain between the macrocell base station (m) and the terminal (i), pₖᵢ^{f} denotes transmission power between a femtocell (k) and the terminal (i), and gₖᵢ^{f} denotes a path gain between the femtocell (k) and the terminal (i).

In the method, the I simultaneous inequalities in operation (b) are defined by:

$${\sum }_{k = 1}^{F} {p}_{k 1}^{f} {g}_{k 1}^{f} \leq \frac{{p}_{m 1} {g}_{m 1}}{{γ}_{1}} - N - {\sum }_{k = 1 , k \neq m}^{M} {p}_{k 1} {g}_{k 1}$$

$${\sum }_{k = 1}^{F} {p}_{k 2}^{f} {g}_{k 2}^{f} \leq \frac{{p}_{m 2} {g}_{m 2}}{{γ}_{2}} - N - {\sum }_{k = 1 , k \neq m}^{M} {p}_{k 2} {g}_{k 2}$$

$$⋮$$

$${\sum }_{k = 1}^{F} {p}_{kI}^{f} {g}_{kI}^{f} \leq \frac{{p}_{mI} {g}_{mI}}{{γ}_{I}} - N - {\sum }_{k = 1 , k \neq m}^{M} {p}_{kI} {g}_{kI} ,$$

where γᵢ denotes an SIR satisfying a service requirement of a terminal according to each terminal.

In the method, the inequalities may be selected in order from the terminal (i) having a high SIR for satisfying a service requirement when the inequalities are sequentially selected one by one from at least some inequalities if the at least some inequalities are not satisfied in operation (c).

In the method, the transmission power may be adjusted in order from transmission power of a femtocell having a large influence on the terminal (i) when the inequalities are sequentially selected one by one from at least some inequalities if the at least some inequalities are not satisfied in operation (c) and the transmission power is adjusted one by one in the terms representing the transmission power of the femtocells in the inequalities. In this case, the femtocell having the large influence on the terminal (i) may be determined on the basis of a distance between the terminal (i) and the femtocell. In this case, the distance between the terminal (i) and the femtocell may be calculated on the basis of a position of the terminal (i) obtained from a global positioning system (GPS) device provided in the terminal (i) and a position of the femtocell obtained from a GPS device provided in the femtocell or a known position of the femtocell.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an environment to which a transmission power control method is applied according to an example embodiment of the present invention; and

FIG. 2 is a flowchart illustrating a method of controlling transmission power of femtocells according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” may refer to a mobile station (MS), user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, and also portable units or terminals having a combination of such functions, but the present invention is not limited thereto.

The term “base station” generally denotes a fixed or mobile point communicating with a terminal, and may be referred to as Node-B, evolved Node-B (eNB), a base transceiver system (BTS), an access point, a relay, a femtocell, and other terms.

Hereinafter, example embodiments of the present invention will be described in detail with reference to the accompanying drawings.

In an example embodiment of the present invention, a heterogeneous network environment of a co-channel frequency allocation scheme in which a macrocell and a femtocell are mixed is assumed to be an environment in which a macrocell overlaps a plurality of femtocells within the macrocell.

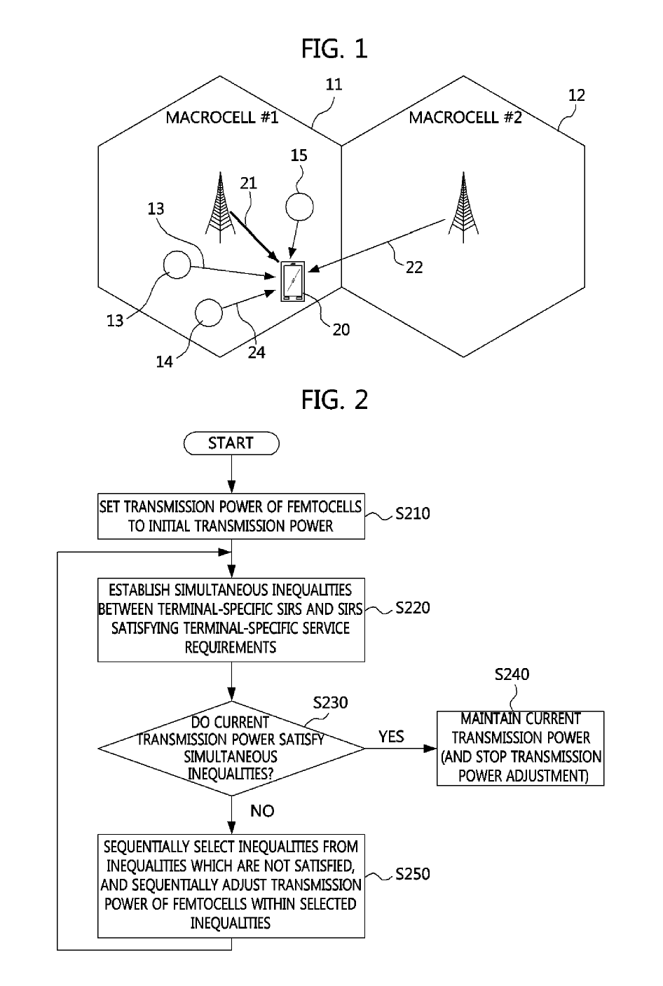

FIG. 1 is a conceptual diagram illustrating an environment to which a transmission power control method is applied according to an example embodiment of the present invention.

Referring to FIG. 1, the environment of the method according to the example embodiment of the present invention is assumed to be an environment in which there are a macrocell #1 (11) and a macrocell #2 (12) adjacent to each other, a plurality of femtocells 13, 14, and 15 within the coverage of the macrocell 11, and a terminal 20 receiving service from the macrocell 11 while receiving interference from the adjacent macrocell 12 and the femtocells 13, 14, and 15.

In FIG. 1, an arrow 21 from the macrocell 11 to the terminal 20 indicates a signal, and arrows 22, 23, 24, and 25 from the macrocell 12 and the femtocells 13, 14, and 15 to the terminal 20 indicate interference.

That is, the terminal 20, which receives service (downlink (DL)) from the macrocell 11, is affected by interference from the plurality of femtocells 13, 14, and 15 using the same channel within the macrocell 11 and the adjacent macrocell 12, so that QoS for the terminal 20 may be degraded due to the interference.

The femtocell has a cell radius within several meters. Because a distance between a base station and a terminal is relatively short in the femtocell compared to the macrocell, interference from the macrocell may be relatively small. That is, a target of interference control between the macrocell and the femtocells may be mainly interference from the femtocell to the terminal of the macrocell.

Problem in Transmission Power Vector Calculation

Under an environment in which there is interference from a femtocell and an external macrocell, an SIR of a terminal i using a DL service from the macrocell is given as shown in the following Expression (1).

$$SIR = \frac{{p}_{mi} {g}_{mi}}{{\sum }_{k = 1 , k \neq i}^{M} {p}_{ki} {g}_{ki} + {\sum }_{k = 1}^{F} {p}_{ki}^{f} {g}_{ki}^{f} + N} \qquad ( 1 )$$

Here, M denotes the number of macrocells, F denotes the number of femtocells, I denotes the number of users, N denotes thermal noise, pₘᵢ denotes transmission power between a macrocell base station m and the terminal i, gₘᵢ denotes a path gain between the macrocell base station m and the terminal i, pₖᵢ^{f} denotes transmission power between a femtocell k and the terminal i, and gₖᵢ^{f} denotes a path gain between the femtocell k and the terminal i.

Each user may desire to receive service at a user-desired minimum service level according to service characteristics. This minimum service level is denoted by γᵢ according to each user. Accordingly, Expression (1) should satisfy an inequality as shown in the following Expression (2).

$$SIR = \frac{{p}_{mi} {g}_{mi}}{{\sum }_{k = 1 , k \neq m}^{M} {p}_{ki} {g}_{ki} + {\sum }_{k = 1}^{F} {p}_{ki}^{f} {g}_{ki}^{f} + N} \geq {γ}_{i} \qquad ( 2 )$$

When the term

$${\sum }_{k = 1 , k \neq m}^{M} {p}_{ki} {g}_{ki} + {\sum }_{k = 1}^{F} {p}_{ki}^{f} {g}_{ki}^{f}$$

representing interference in Expression (2) is expanded, the following Expression (3) is given.

$${\sum }_{k = 1 , k \neq m}^{M} {p}_{ki} {g}_{ki} + {\sum }_{k = 1}^{F} {p}_{ki}^{f} {g}_{ki}^{f} \leq \frac{{p}_{mi} {g}_{mi}}{{γ}_{i}} - N \qquad ( 3 )$$

Expression (3) is the most basic power control formula for satisfying a basic service level of a user in an existing mobile communication system if there is no interference from the femtocell.

Because the present invention is aimed at improving QoS for a user (terminal) who receives service from the macrocell by controlling transmission power of the femtocell, the macrocell's transmission power pₖᵢ is handled as a constant, not a variable.

For the term

$${\sum }_{k = 1}^{F} {p}_{ki}^{f} {g}_{ki}^{f}$$

representing interference from the femtocell in Expression (3), simultaneous inequalities of the following Expressions (4) for all users (i=1, . . . , I) are obtained.

$$\begin{matrix}{\sum }_{k = 1}^{F} {p}_{k 1}^{f} {g}_{k 1}^{f} \leq \frac{{p}_{m 1} {g}_{m 1}}{{γ}_{1}} - N - {\sum }_{k = 1 , k \neq m}^{M} {p}_{k 1} {g}_{k 1} & ( 4 ) \\ {\sum }_{k = 1}^{F} {p}_{k 2}^{f} {g}_{k 2}^{f} \leq \frac{{p}_{m 2} {g}_{m 2}}{{γ}_{2}} - N - {\sum }_{k = 1 , k \neq m}^{M} {p}_{k 2} {g}_{k 2} & \\ ⋮ & \\ {\sum }_{k = 1}^{F} {p}_{kI}^{f} {g}_{kI}^{f} \leq \frac{{p}_{mI} {g}_{mI}}{{γ}_{I}} - N - {\sum }_{k = 1 , k \neq m}^{M} {p}_{kI} {g}_{kI} & \end{matrix}$$

Transmission power vectors of the femtocells (k=1, . . . , F) may be obtained by solving the above-described simultaneous inequalities (Expressions (4)). However, there are two problems when the transmission power vectors of the femtocells are obtained by solving the above-described simultaneous inequalities.

The first problem is that a solution of the inequalities may not be obtained when the number of users (terminals) connected to the macrocell is greater than the number of femtocells. Assuming that a transmission power vector of the macrocell is obtained using the expansion of mathematical expressions for basic transmission power control described above, simultaneous inequalities with M variables are expanded as in Expressions (4) and a total of M inequalities are generated. In this case, a feasible solution for the transmission power of the macrocell may be found according to the presence/absence of an inverse matrix. If there is a solution, its value may be easily derived. However, because a desired value to be obtained using Expressions (4) is a transmission power vector of the femtocell, the number of inequalities becomes the number of users (terminals), so that a problem may not be solved if the number of femtocells is greater than the number of users.

The second problem is that although an expansion process from Expression (3) to Expressions (4) may be mathematically expressed, it is significantly difficult to operate the process in reality. Although it is possible to determine a total amount of interference indicating how much interference each terminal receives, it is significantly difficult to separately find interference from the macrocell and interference from the femtocell in the total amount of interference.

### Heuristic Method of Calculating Transmission Power Vector According to Example Embodiment of Present Invention

The present invention proposes a heuristic method of deriving a transmission power vector of a femtocell satisfying Expressions (4).

In general, it is possible to consider a method based on the following Expression (5) as a method of determining a level of initial transmission power of the femtocell. Of course, although the following Expression (5) is used to explain one example in which the initial transmission power is obtained, the method of determining the initial transmission power of the femtocell is not limited to the following Expression (5).

P_{femto}=min(P_{macro}, Pₘₐₓ) (5)

That is, in the method of Expression (5), the initial transmission power is determined to be transmission power for maintaining received signal intensity from a macrocell at a predetermined distance from each of the femtocells and received signal intensity from the femtocell at the same level. For example, assuming that a radius of the femtocell is about 10 meters, the predetermined distance may be about 10 meters. In this case, although other parameters may be actually considered in P_{macro} related to the received intensity from the macrocell, the other parameters are not handled in detail in the present invention. For a user located at a distance of 10 meters from the center of the femtocell, the transmission power of the femtocell is interpreted to have the same received intensity as the received intensity of the macrocell.

First, each femtocell base station determines its own transmission power according to Expression (5). Values determined as described above are substituted into the simultaneous inequalities of Expressions (4). If the results satisfy all the inequalities, each femtocell directly uses transmission power determined according to Expression (5).

If at least some inequalities among the simultaneous inequalities of Expressions (4) are not satisfied, femtocells need to improve QoS for macrocell terminals by re-adjusting their transmission power. If an i-th inequality is not established, it means that QoS for an i-th terminal is not satisfied.

Assuming that one or more inequalities among I inequalities are not established, a terminal having highest priority for transmission power of the femtocell may have a largest service requirement (γᵢ) value. If the value of γᵢ is largest, it may mean that a system's constraint is largest. Assuming that the value of γᵢ of the i-th terminal is largest and does not satisfy an inequality, an inequality having a largest value of γᵢ among the simultaneous inequalities of Expressions (4) may be expanded as shown in the following Expression (6).

$${p}_{1 i}^{f} {g}_{1 i}^{f} + {p}_{2 i}^{f} {g}_{2 i}^{f} + {p}_{3 i}^{f} {g}_{3 i}^{f} + … + {p}_{Fi}^{f} {g}_{Fi}^{f} \leq \frac{{p}_{mi} {g}_{mi}}{{γ}_{i}} - N - {\sum }_{k = 1 , k \neq m}^{M} {p}_{ki} {g}_{ki} \qquad ( 6 )$$

The left term of Expression (6) is a feasible solution in terms of each femtocell, but may not be a feasible solution in terms of the entire system. It is necessary to reduce a value of the left term so that Expression (6) is satisfied. That is, although the transmission power of a specific femtocell is reduced in Expression (6), it does not affect other inequalities satisfying Expressions (4). Accordingly, the reduction of the value of the left term in Expression (6) is not problematic in the entire system.

In this case, a femtocell having a largest influence on the terminal i is found. The found femtocell is more likely to be a femtocell closest to a position of the terminal i. A distance between the femtocell and the terminal i may be calculated on the basis of positions of the terminal and the femtocell found using GPS devices provided in the terminal and the femtocell. Alternatively, a known position of the femtocell may also be used.

Assuming that the femtocell having the largest influence on the terminal i is a femtocell k, the transmission power of the femtocell k is derived from Expression (7).

$${p}_{ki}^{f} {g}_{li}^{f} = \frac{{p}_{mi} {g}_{mi}}{{γ}_{i}} - N - {\sum }_{k = 1 , k \neq m}^{M} {p}_{ki} {g}_{ki} - ( {p}_{1 i}^{f} {g}_{1 i}^{f} + {p}_{2 i}^{f} {g}_{2 i}^{f} + … + {p}_{Fi}^{f} {g}_{Fi}^{f} ) \qquad ( 7 )$$

If a value of pₖᵢ^{f} is equal to or less than 0, it means that a corresponding femtocell should be shut down, and QoS for the terminal i is not satisfied by only control for the femtocell k. That is, because the equality of Expression (7) is not satisfied even when the transmission power of the femtocell k is completely turned off, transmission power of another femtocell needs to be additionally controlled.

In this case, Expression (7) is re-calculated in a state in which pₖᵢ^{f}=0 by finding to the next closest femtocell to the terminal i after the femtocell k. Through this method, the inequality is re-calculated by substituting a power vector value of transmission power of a newly determined femtocell into Expressions (4). Accordingly, the user i requesting highest QoS may be satisfied.

It has been assumed that one or more inequalities among simultaneous inequalities calculated by Expression (5) may not be satisfied. In a state in which a problem has been solved for the user i requesting highest QoS, the next target becomes a user j requesting second highest QoS. As in the case of the user i, a power vector of a femtocell satisfying QoS may be obtained using Expressions (6) and (7). Alternatively, because magnitudes of transmission power of a plurality of femtocells are reduced in a process of solving the problem for the user i, the problem may be simultaneously solved.

Through this method, it is possible to satisfy QoS necessary for all users by minimizing interference from femtocells to all the users.

### Method of Controlling Transmission Power of Femtocells According to Example Embodiment of Present Invention

FIG. 2 is a flowchart illustrating a method of controlling transmission power of femtocells according to an example embodiment of the present invention.

Referring to FIG. 2, according to the example embodiment of the present invention, there is provided a method of controlling transmission power of femtocells when there are I (I is a natural number) user terminals (i=1, . . . , I) that are receiving service from one macrocell (m) among M (M is a natural number) macrocells in a heterogeneous network environment in which the M macrocells overlap F (F is a natural number) femtocells, including: (a) setting transmission power of the femtocells to initial transmission power (S210); (b) establishing inequalities between received SIRs of the I user terminals and SIRs satisfying service requirements of the terminals as I simultaneous inequalities (S220); (c) identifying whether the inequalities constituting the simultaneous inequalities are satisfied (S230); and (d) maintaining currently adjusted transmission power and stopping transmission power adjustment of the femtocells if all the inequalities are satisfied in operation (c) (S240), wherein operations (c) and (d) are iterated while inequalities are sequentially selected one by one from at least some inequalities if at least some inequalities are not satisfied in operation (c) and transmission power is adjusted one by one in terms representing the transmission power of femtocells in the inequalities (S250).

The initial transmission power of the femtocells in operation (a) (S210) may be selected as transmission power for maintaining received signal intensity from a macrocell at a predetermined distance from each of the femtocells and received signal intensity from the femtocell at the same level. For example, as described above with reference to Expression (5), the initial transmission power of the femtocell may be determined by considering other parameters in the received intensity from the macrocell.

In operation (b) (S220) of establishing the inequalities between the received SIRs of the I user terminals and the SIRs satisfying the service requirements of the terminals as the I simultaneous inequalities, an expression for calculating the SIRs as shown in Expression (2) and the simultaneous inequalities of Expressions (4) may be used.

That is, from a point of view of each terminal, an SIR expressed by Expression (2) should be equal to or less than an SIR satisfying a service requirement of each terminal. If inequalities are established for the I terminals, it is possible to establish simultaneous inequalities constituted by I inequalities as in Expressions (4) in which terms representing transmission power of the F femtocells for satisfying service requirements of the terminals are arranged on left sides thereof.

In operation (c) (S230), it is determined whether the simultaneous inequalities established in operation (b) (S220) are satisfied at currently set transmission power of the femtocells. That is, it is determined whether the simultaneous inequalities established in operation (b) (S220) are satisfied at the transmission power set to the initial transmission power in operation (a) (S210). Along with operation (d) (S240), operation (c) (S230) is iterated to determine whether currently adjusted transmission power of the femtocells satisfy the simultaneous inequalities while the transmission power of the femtocells is adjusted by a heuristic method.

In operation (d) (S240), currently adjusted transmission power is maintained if all the inequalities are satisfied in operation (c). In this case, because the currently set transmission power of the femtocells may satisfy service requirements of all the terminals, the currently adjusted transmission power is determined to be final transmission power and transmission power adjustment of the femtocells are stopped.

If it is determined that at least some inequalities among all the inequalities are not satisfied in operation (c) (S230), operations (c) and (d) may be configured to be iterated while inequalities are sequentially selected one by one from at least some inequalities, which are not satisfied, and transmission power is adjusted one by one in terms representing the transmission power of femtocells included in the inequalities.

In this case, the inequalities are sequentially selected in order from an inequality for a terminal having a high service requirement (a high SIR). A femtocell of which transmission power should be adjusted within a selected inequality may be selected as a femtocell that may have a largest influence on a selected terminal.

In this case, the influence on the terminal may be determined using a distance between the femtocell and the terminal. The determination may be made by the distance between the terminal and the femtocell on the basis of a position of the terminal obtained from a GPS device provided in the terminal and a position of the femtocell obtained from a GPS device provided in the femtocell or a known position of the femtocell. For example, it may be determined that the femtocell has a large influence on the terminal when a femtocell is close to the terminal

In the process as described above, operations (c) and (d) are iterated while transmission power of femtocells is adjusted in descending order of service requirement for the terminal and in descending order of influence on the terminal, so that the transmission power of the femtocells is adjusted until service requirements of all terminals are satisfied.

When the transmission power control method according to the above-described example embodiment of the present invention is used, QoS for users within a macrocell may be improved by efficiently controlling transmission power of femtocells that may interfere with the users within the macrocell in a heterogeneous network environment in which macrocells overlap femtocells.

While the example embodiments of the present invention and their advantages have been described in detail, it should be understood that various changes, substitutions and alterations may be made herein without departing from the scope of the invention.

What is claimed is:

1. A method of controlling transmission power of femtocells when there are I (I is a natural number) user terminals (i=1, . . . , I) that are receiving service from one macrocell (m) among M (M is a natural number) macrocells in a heterogeneous network environment in which the M macrocells overlap F (F is a natural number) femtocells, comprising:
(a) setting the transmission power of the femtocells to initial transmission power;
(b) establishing inequalities between received signal to interference ratios (SIRs) of the I user terminals and SIRs satisfying service requirements of the terminals as I simultaneous inequalities;
(c) identifying whether the inequalities constituting the simultaneous inequalities are satisfied; and
(d) maintaining currently adjusted transmission power and stopping transmission power adjustment of the femtocells if all the inequalities are satisfied in operation (c),
wherein operations (c) and (d) are iterated while inequalities are sequentially selected one by one from at least some inequalities if the at least some inequalities are not satisfied in operation (c) and transmission power is adjusted one by one in terms representing the transmission power of femtocells in the inequalities.

2. The method of claim 1, wherein the initial transmission power in operation (a) is transmission power for maintaining received signal intensity from a macrocell at a predetermined distance from each of the femtocells and received signal intensity from the femtocell at the same level.

3. The method of claim 1, wherein the received SIRs of the I user terminals in operation (b) are defined by:
$$SIR = \frac{{p}_{mi} {g}_{mi}}{{\sum }_{k = 1 , k \neq i}^{M} {p}_{ki} {g}_{ki} + {\sum }_{k = 1}^{F} {p}_{ki}^{f} {g}_{ki}^{f} + N} ,$$
where M denotes the number of macrocells, F denotes the number of femtocells, I denotes the number of users, N denotes thermal noise, pₘᵢ denotes transmission power between a macrocell base station (m) and the terminal (i), gₘᵢ denotes a path gain between the macrocell base station (m) and the terminal (i), pₖᵢ^{f} denotes transmission power between a femtocell (k) and the terminal (i), and gₖᵢ^{f} denotes a path gain between the femtocell (k) and the terminal (i).

4. The method of claim 3, wherein the I simultaneous inequalities in operation (b) are defined by:
$${\sum }_{k = 1}^{F} {p}_{k 1}^{f} {g}_{k 1}^{f} \leq \frac{{p}_{m 1} {g}_{m 1}}{{γ}_{1}} - N - {\sum }_{k = 1 , k \neq m}^{M} {p}_{k 1} {g}_{k 1}$$
$${\sum }_{k = 1}^{F} {p}_{k 2}^{f} {g}_{k 2}^{f} \leq \frac{{p}_{m 2} {g}_{m 2}}{{γ}_{2}} - N - {\sum }_{k = 1 , k \neq m}^{M} {p}_{k 2} {g}_{k 2}$$
$$⋮$$
$${\sum }_{k = 1}^{F} {p}_{kI}^{f} {g}_{kI}^{f} \leq \frac{{p}_{mI} {g}_{mI}}{{γ}_{I}} - N - {\sum }_{k = 1 , k \neq m}^{M} {p}_{kI} {g}_{kI} ,$$
where γᵢ denotes an SIR satisfying a service requirement of a terminal according to each terminal.

5. The method of claim 1, wherein the inequalities are selected in order from the terminal (i) having a high SIR for satisfying a service requirement when the inequalities are sequentially selected one by one from at least some inequalities if the at least some inequalities are not satisfied in operation (c).

6. The method of claim 1, wherein the transmission power is adjusted in order from transmission power of a femtocell having a large influence on the terminal (i) when the inequalities are sequentially selected one by one from at least some inequalities if the at least some inequalities are not satisfied in operation (c) and the transmission power is adjusted one by one in the terms representing the transmission power of the femtocells in the inequalities.

7. The method of claim 6, wherein the femtocell having the large influence on the terminal (i) is determined on the basis of a distance between the terminal (i) and the femtocell.

8. The method of claim 7, wherein the distance between the terminal (i) and the femtocell is calculated on the basis of a position of the terminal (i) obtained from a global positioning system (GPS) device provided in the terminal (i) and a position of the femtocell obtained from a GPS device provided in the femtocell or a known position of the femtocell.
